(19) United States
(12) Patent Application Publication
(10) Pub. No.: US 2025/0150136 A1
(43) Pub. Date: May 8, 2025

(54) CHANNEL STATUS INDICATION FEEDBACK INFORMATION TRANSMISSION METHOD, COMMUNICATION DEVICE, AND STORAGE MEDIUM

(71) Applicant: Beijing Xiaomi Mobile Software Co., Ltd., Beijing (CN)

(72) Inventor: Qin MU, Beijing (CN)

(21) Appl. No.: 18/838,059

(22) PCT Filed: Feb. 17, 2022
(86) PCT No.: PCT/CN2022/076689

§ 371 Date: Aug. 13, 2024

(51) Int. Cl. H04B 7/06; H04L 5/00

(52) U.S. Cl. CPC H04B 7/0626; H04L 5/0051

(57) ABSTRACT

A method for transmitting Channel State Indicator (CSI) feedback information is performed by a User Equipment (UE), and includes: determining CSI feedback corresponding to each basic unit according to the basic unit of a CSI processing granularity, wherein the basic unit is smaller than a CSI measurement resource indicated by a network side; and sending the CSI feedback information comprising the CSI feedback to a base station.

### CROSS REFERENCE TO RELATED APPLICATION(S)

The present application is a U.S. National Stage of International Application No. PCT/CN2022/076689 filed on Feb. 17, 2022, the content of which is incorporated herein by reference in its entirety.

### TECHNICAL FIELD

The present application relates to, but is not limited to, the field of wireless communication technology, and in particular to a method for transmitting Channel Status Indicator (CSI) feedback information, a communication device, and a storage medium.

### BACKGROUND

In the fifth generation (5G) mobile communication system, Channel Status Indication (CSI) can be used to indicate the number of information streams that a channel can carry, the quality or signal-to-noise ratio of the channel, the channel matrix, etc. As the number of antennas increases, the overhead of CSI feedback also increases. In particular, Precoding Matrix Indicator (PMI) representing the channel matrix in CSI further increases the overhead of CSI feedback.

The third generation cooperation project (3GPP) uses type I/II codebooks to feedback the channel matrix. Type I/II codebooks are based on DFT vectors, and there is such a precondition for them that the antenna array is divided into horizontal and vertical dimensions, and the antennas are evenly arranged in each dimension. This imposes a great limitation on the subsequent hardware design for antennas, and it is impossible to optimize special antennas for different scenarios.

Type I/II codebook design is based on an assumption of uniform distribution for signal incident and departure angles. However, in actual environments, the statistical laws for signal arrival and departure angles, etc. are not uniform distributions, and the statistical law for each base station device is also different, so there is room for optimization. 3) Type I/II codebooks have their own application scopes. Type I codebooks are relatively simple, but have limited accuracy and are designed for single-user transmission. Type II codebooks have high accuracy and can be used for multi-user transmission. With accurate channel feedbacks, inter-user interference can be eliminated in a better way between multiple users, but the overhead is too large and there is a lot of room for optimization.

### SUMMARY

In view of above, embodiments of the present disclosure provide a method and apparatus for transmitting CSI feedback information, a communication device, and a storage medium.

According to a first aspect of embodiments of the present disclosure, a method for transmitting CSI feedback information is provided, which is performed by a User Equipment (UE), and includes:

determining a CSI feedback corresponding to each basic unit according to the basic unit of a CSI processing granularity, where the basic unit is smaller than a CSI measurement resource indicated by a network side; and
sending the CSI feedback information including the CSI feedback to a base station.

According to a second aspect of embodiments of the present disclosure, a method for transmitting CSI feedback information is provided, which is performed by a base station, and includes:

receiving CSI feedback information for a plurality of basic units sent by a User Equipment UE, where the CSI feedback information includes CSI feedback corresponding to each basic unit, the CSI feedback is determined by the UE according to the basic unit corresponding to a CSI processing granularity, and the basic unit is smaller than a CSI measurement resource indicated by a network side.

According to a third aspect of embodiments of the present disclosure, an apparatus for transmitting CSI feedback information is provided, which is applied to a User Equipment UE and includes:

a first processing module, configured to determine CSI feedback corresponding to each basic unit according to the basic unit of a CSI processing granularity, where the basic unit is smaller than a CSI measurement resource indicated by a network side; and
a first transceiving module, configured to send the CSI feedback information including the CSI feedback to a base station.

According to a fourth aspect of embodiments of the present disclosure, an apparatus for transmitting CSI feedback information is provided, which is applied to a base station and includes: a second transceiving module, configured to receive CSI feedback information for a plurality of basic units sent by a User Equipment UE, where the CSI feedback information includes CSI feedback corresponding to each basic unit, the CSI feedback is determined by the UE according to the basic unit corresponding to a CSI processing granularity, and the basic unit is smaller than a CSI measurement resource indicated by a network side.

According to a fifth aspect of embodiments of the present disclosure, a communication device is provided, comprising: a processor, a memory, and an executable program stored on the memory and capable of being run by the processor, where the processor is configured to perform steps of the method for transmitting CSI feedback information as described in the first aspect or the second aspect when running the executable program.

According to a sixth aspect of embodiments of the present disclosure, a storage medium is provided, on which an executable program is stored, where the executable program, when executed by a processor, implements steps of the method for transmitting CSI feedback information as described in the first aspect or the second aspect.

According to the method and apparatus for transmitting CSI feedback information, the communication device, and the storage medium provided by the embodiments of the present disclosure, the UE determines the CSI feedback corresponding to each basic unit according to the basic unit of the CSI processing granularity, where the basic unit is smaller than the CSI measurement resource indicated by the network side; and the UE sends the CSI feedback information including the CSI feedback to the base station. In this way, the basic unit smaller than the CSI measurement resource is used as the CSI processing granularity, so that UEs that do not have the CSI measurement resource as the processing granularity for CSI processing can perform CSI processing, thereby increasing the types of UEs that can perform CSI processing, reducing the resource overhead of UEs with weak compression capabilities, and improving the efficiency of CSI feedback.

It should be understood that the above general description and the detailed description below are only examples and explanatory, and cannot limit the embodiments of the present disclosure.

### BRIEF DESCRIPTION OF THE DRAWINGS

The accompanying drawings herein are incorporated into and constitute a part of the specification, and illustrate the principle of the embodiments of the present disclosure and are used together with the specification to explain the embodiments of the present disclosure.

FIG. 1 is a schematic structural diagram of a wireless communication system according to an example embodiment;

FIG. 2 is a schematic diagram of a flow chart of a method for transmitting CSI feedback information according to an example embodiment;

FIG. 3 is a schematic diagram of CSI feedback according to an example embodiment;

FIG. 4 is a schematic diagram of a flow chart of another method for transmitting CSI feedback information according to an example embodiment;

FIG. 5 is a schematic diagram of a flow chart of another method for transmitting CSI feedback information according to an example embodiment;

FIG. 6 is a block diagram of an apparatus for transmitting CSI feedback information according to an example embodiment;

FIG. 7 is a block diagram of another apparatus for transmitting CSI feedback information according to an example embodiment; and

FIG. 8 is a block diagram of an apparatus for transmitting CSI feedback information according to an example embodiment.

### DETAILED DESCRIPTION OF THE EMBODIMENTS

Here, example embodiments will be described in detail, and examples thereof are shown in the accompanying drawings. When the following description refers to the drawings, unless otherwise indicated, the same numbers in different drawings represent the same or similar elements. The embodiments described in the following example embodiments do not represent all the embodiments consistent with the embodiments of the present disclosure. Instead, they are only examples of apparatus and methods consistent with some aspects of the embodiments of the present disclosure as attached.

The terms used in the embodiments of the present disclosure are only for the purpose of describing specific embodiments and are not intended to limit the embodiments of the present disclosure. The singular forms “one”, “said” and “the” used in the embodiments of the present disclosure are also intended to include plural forms, unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “at the time of” or “when” or “in response to determining”.

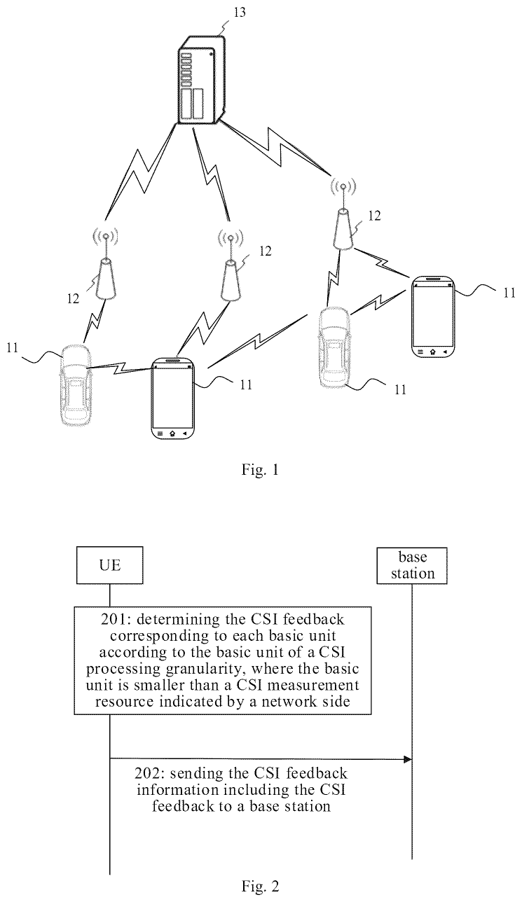

Reference may be made to FIG. 1, which shows a schematic structural diagram of a wireless communication system provided by an embodiment of the present disclosure. As shown in FIG. 1, the wireless communication system is a communication system based on cellular mobile communication technology, and the wireless communication system may include a number of terminals 11 and a number of base stations 12.

The terminal 11 may be a device that provides voice and/or data connectivity to a user. The terminal 11 may communicate with one or more core networks via a Radio Access Network (RAN). The terminal 11 may be an Internet of Things terminal, such as a sensor device, a mobile phone (or a “cellular” phone), and a computer with an Internet of Things terminal. For example, it may be a fixed, portable, pocket-sized, handheld, computer-built-in, or vehicle-mounted device. For example, it may be a station (STA), subscriber unit, subscriber station, mobile station, mobile, remote station, access point, remote terminal, access terminal, user terminal, user agent, user device, or User Equipment (UE). Alternatively, the terminal 11 may also be a device of an unmanned aerial vehicle. Alternatively, the terminal 11 may also be a vehicle-mounted device, such as a driving computer with wireless communication function, or a wireless communication device connected to an external driving computer. Alternatively, the terminal 11 may also be a roadside device, such as a street lamp, signal lamp, or other roadside device with wireless communication function.

The base station 12 may be a network-side device in a wireless communication system. The wireless communication system may be a 4th generation mobile communication (4G) system, also known as a Long Term Evolution (LTE) system. Alternatively, the wireless communication system may be a 5G system, also known as a New Radio (NR) system or a 5G NR system. Alternatively, the wireless communication system may be a next generation system of the 5G system. The access network in the 5G system may be called a New Generation-Radio Access Network (NG-RAN). Alternatively, it may be an MTC system.

The base station 12 may be an evolved Base Station (eNB) used in a 4G system. Alternatively, the base station 12 may also be a Base Station (gNB) using a centralized distributed architecture in a 5G system. When the base station 12 uses a centralized distributed architecture, it generally includes a Centralized Unit (CU) and at least two Distributed Units (DUs). The centralized unit is provided with a protocol stack of a Packet Data Convergence Protocol (PDCP) layer, a Radio Link Layer Control (RLC) layer, and a Media Access Control (MAC) layer. The distributed unit is provided with a physical (PHY) layer protocol stack. The specific implementations of the base station 12 are not limited in the embodiments of the present disclosure.

A wireless connection may be established between the base station 12 and the terminal 11 through a wireless air interface. In different implementations, the wireless air interface is a wireless air interface based on the fourth generation mobile communication network technology (4G) standard. Alternatively, the wireless air interface is a wireless air interface based on the fifth generation mobile communication network technology (5G) standard. For example, the wireless air interface is a new air interface. Alternatively, the wireless air interface may also be a wireless air interface based on the next generation mobile communication network technology standard of 5G.

In some embodiments, an End to End (E2E) connection may also be established between the terminals 11, such as in scenario like Vehicle to Vehicle (V2V) communication, Vehicle to Infrastructure (V2I) communication, and Vehicle to Pedestrian (V2P) communication among Vehicle to Everything (V2X) communication.

In some embodiments, the wireless communication system may further include a network management device 13.

Several base stations 12 are respectively connected to the network management device 13. The network management device 13 may be a core network device in a wireless communication system. For example, the network management device 13 may be a core network device in a wireless communication system, such as Access and Mobility Management Function (AMF), Session Management Function (SMF), User Plane Function (UPF), Policy Control Function (PCF), Network Repository Function (NRF), etc. The implementation forms of the network management device 13 are not limited in the embodiments of the present disclosure.

The execution subjects involved in the embodiments of the present disclosure include, but are not limited to: UEs such as mobile phone terminals in cellular mobile communication systems, and network-side devices such as access network devices like base stations, and core networks, etc.

The related technology uses Artificial Intelligence (AI) learning models for AI compression.

The introduction of AI technology helps to effectively solve the problems existing in Type I/II codebooks.
1) For non-aligned antenna arrays of the base station, channel data is obtained through simulation modeling, field data collection, etc., and special AI network training is performed to obtain a matching AI network.
2) For complex actual scenarios, special optimization for a certain base station may also be performed through field data collection.
3) For different scenarios and requirements, different feedback bits may be used to train the AI network for achieving channel matrix feedback with any feedback bit and any accuracy requirement.

The AI-based CSI compression scheme considers using the image compression performance of AI, processing by using the full channel information or feature vector as the image to be compressed, and performing image restoration at the receiving end, for the base station to adjust the corresponding parameters.

Different numbers of input parameters in CSI compression require different AI models.

In related technologies, AI models perform CSI compression based on full bandwidth (such as BWP). Such compression can make full use of the channel correlation in frequency domain, but there are also problems as follows in actual deployments.

In actual deployments, different BWPs or different CSI measurement resources may be configured for the terminal. If full bandwidth compression is performed at this time, corresponding AI models are required to match under different configurations. These impose huge challenges to air interface overhead, terminal storage, and model management

In addition, different terminals have different processing capabilities. Some terminals can perform large-bandwidth, multi-input and multi-output AI compression inference; while other terminals can only perform small-bandwidth AI processing and do not support large-bandwidth AI processing.

Therefore, how to reduce the management complexity of AI models, improve the flexibility of AI model applications, and enable AI models to adapt to terminals with different capabilities, becomes an urgent problem to be solved.

As shown in FIG. 2, an example embodiment provides a method for transmitting Channel Status Indicator (CSI) feedback information that can be performed by a UE of a cellular mobile communication system and includes the following steps.

Step 201: determining the CSI feedback corresponding to each basic unit according to the basic unit of a CSI processing granularity, where the basic unit is smaller than a CSI measurement resource indicated by a network side.

Step 202: sending the CSI feedback information including the CSI feedback to a base station.

UE may be a terminal such as a mobile phone in a communication system.

In an embodiment of the present disclosure, the basic unit is smaller than the CSI measurement resource indicated by the network side. CSI may be used by the UE to feedback the downlink channel quality to the base station. The CSI measurement resource may be a time domain resource and/or a frequency domain resource of the downlink channel that the CSI can feedback. In one implementation, the CSI measurement resource may be an activated BWP of the UE. In one implementation, the basic unit is smaller than the activated BWP. That is, the activated BWP of the UE is divided into at least two basic units, so that the UE determines the CSI feedback for the basic unit.

In an embodiment of the present disclosure, the CSI measurement resource may be divided into I basic units, and I CSI feedbacks may be spliced into the complete CSI feedback information and sent to the base station. In an example, all of the I CSI feedbacks may be sent to the base station, and the base station may splice them into the complete CSI feedback information.

In an embodiment of the present disclosure, UE may perform CSI processing on all or part of the basic units, and generate CSI feedback information and send it to the base station.

The CSI measurement resource may be indicated by the network side. UE may measure the channel quality within the CSI measurement resource range and provide feedback through CSI.

In an example, the CSI measurement resource may be the full bandwidth of the current data communication between the UE and the base station, or the bandwidth occupied by the CSI-RS configured by the network side, or the bandwidth range configured by the network side. The bandwidth occupied by the CSI-RS may be the bandwidth occupied by the CSI-RS at the same time domain position, or the bandwidth occupied by the CSI-RS at different time domain positions.

In an example, the UE may use an AI model to perform processing by using the basic unit as the processing granularity within the CSI measurement resource range, so that the CSI feedback corresponding to each basic unit within the CSI measurement resource range is obtained.

The UE may use the basic unit as the processing granularity, divide the CSI measurement resource into a plurality of basic units, and perform CSI processing on each basic unit, so that the CSI feedback corresponding to each basic unit is obtained. The processing may include any of the following: measurement, prediction, or compression.

The basic unit may be the minimum resource unit of the downlink channel corresponding to the CSI that UE can feedback. The basic unit may be a time domain resource and/or a frequency domain resource of the downlink channel. The basic unit may be determined based on the processing capability of the UE. For example, the bandwidth corresponding to the CSI feedback that can be processed by the UE with poor performance may be used as the basic unit. That is, UEs with different processing capabilities may use the basic unit as the processing granularity for the purpose of processing. The bandwidth corresponding to the CSI feedback may be the bandwidth of the downlink channel corresponding to the fed-back CSI.

For example, the basic unit for processing CS may be defined as 4 RBs or 8 RBs in frequency domain. In an implementation, the basic unit may be determined according to the number of RBs of the BWP corresponding to the UE. For example, when the BWP bandwidth is larger than X RBs, the size of the basic unit is 8 RBs; otherwise, the size of the basic unit is 4 RBs.

In one embodiment, the CSI measurement resource includes I basic units, where I is a positive integer greater than or equal to 2.

When the network configures the CSI measurement resource for the terminal that needs CSI feedback, the configuration may be done with the basic unit acting as the allocation unit. The network side configures the CSI measurement resource as an integer number of basic units. For example, when the basic unit is 6 RBs, the physical resources corresponding to the object for the respective CSI measurement and feedback, that is, the CSI measurement resources, are integer multiples of 6 RBs.

In one embodiment, the sending the CSI feedback information comprising the CSI feedback to the base station includes: sending the CSI feedback information comprising the CSI feedback corresponding to a plurality of basic units respectively.

The CSI measurement resource may be divided into I basic units to determine the CSI feedback corresponding to each basic unit. The CSI feedback corresponding to each basic unit may be combined into the CSI feedback information, and the CSI feedback information may be sent to the base station. I is a positive integer greater than or equal to 2. In this way, the CSI feedback information of the CSI measurement resource can be fed back to realize the channel quality feedback within the CSI measurement resource range. It is noted that in all embodiments of the present disclosure, the CSI measurement resource may also be divided into I basic units and the CSI feedback corresponding to some of the basic units can be determined. Then, these CSI feedbacks are combined into the CSI feedback information, and the CSI feedback information is sent to the base station.

In this way, a basic unit smaller than the CSI measurement resource (such as BWP bandwidth) is used as the CSI processing granularity, so that UEs that do not have CSI measurement resources as the processing granularity for the purpose of CSI processing can perform CSI processing. This increases the types of UEs that can perform CSI processing, reduces the resource overhead of UEs with weak compression capabilities, and improves the efficiency of CSI feedback.

In one embodiment, the CSI measurement resource is 1 BandWidth Part BWP.

The network side may allocate one or more BWPs to the UE. At the same time domain position, the UE may activate a BWP for data transmission. The UE may perform channel measurement or prediction for the activated BWP.

For example, as shown in FIG. 3, a BWP may be divided into 4 basic units: H1˜H4, and CSI processing is performed based on each basic unit respectively to obtain 4 CSI feedbacks. The 4 CSI feedbacks are spliced into the complete CSI feedback information and sent to the base station.

The basic unit is smaller than the CSI measurement resource indicated by the network side. This may include that the basic unit is a subband of a BWP in frequency domain.

In one embodiment, the basic unit covers N frequency domain resources corresponding to the Channel State Indicator-Reference Signal CSI-RS in frequency domain, where N is a positive integer and N is less than M, and M is the total number of frequency domain resources corresponding to the CSI-RS indicated by the network side.

The network side may indicate the total number M of frequency domain resources of the CSI-RS that requires measurement by the UE. The CSI measurement resource may be the bandwidth occupied by the M frequency domain resources. The UE may use the bandwidth occupied by the N frequency domain resources as the granularity and the basic unit for CSI processing, so that CSI feedback corresponding to each basic unit is obtained.

In one embodiment, the time domain positions of the M frequency domain resources may be the same or may not be all the same. The CSI processing results of the CSI-RS at different time domain positions may be sent to the base station through the same CSI feedback information.

In one embodiment, the time domain positions of the N frequency domain resources are the same.

Alternatively, the time domain positions of the N frequency domain resources are not all the same.

The N frequency domain resources covered by the basic unit may have the same time domain position. The basic unit may also cover N frequency domain resources at different time domain positions. The UE may also compress N frequency domain resources at different time domain positions into one CSI feedback. That is, N frequency domain resources at different time domain positions are used as the CSI processing unit.

In one embodiment, the determining the CSI feedback corresponding to each basic unit according to the basic unit of the CSI processing granularity includes: determining the basic unit of the CSI processing granularity; and determining the CSI corresponding to each basic unit according to a machine learning model corresponding to the basic unit.

In an example, the basic unit may be determined based on the processing capability of the UE. For example, the bandwidth corresponding to the CSI feedback that can be processed by a UE with poor performance may be used as a basic unit. That is, UEs with different processing capabilities may use the basic unit as the processing granularity for the purpose of processing. In an example, the basic unit may also be determined based on the number of CSI measurement resources. If there are more CSI measurement resources, the basic unit may be configured to be larger. If there are fewer CSI measurement resources, the basic unit may be configured to be smaller.

The machine learning model may perform CSI processing on the corresponding basic unit to obtain the CSI feedback of the basic unit. The machine learning model may include an AI model, etc.

For the plurality of basic units included in the CSI measurement resource, the machine learning model may be used to perform processing on the CSI of each basic unit respectively. One machine learning model may correspond to one basic unit or multiple basic units.

The number of basic units included in different CSI measurement resources may be different. The machine learning model may be determined for each basic unit, so that the machine learning model may be used to perform CSI processing during the CSI processing process. The machine learning model may be determined by the network side device and then configured to the UE, or may be determined by the UE, or may be determined by the UE and the network side device together.

In an implementation, the network side may indicate different CSI measurement resources. The UE may determine the machine learning model from the pre-configured machine learning model for CSI processing. In this way, there is no need to retrain or configure the machine learning model according to the parameters of each CSI measurement resource, thereby reducing the management complexity of the machine learning model.

The machine learning model may be deployed at the UE side for CSI compression and other processing, so that the CSI feedback is obtained. The machine learning model may also be deployed at the network side, such as a base station, for decompressing the CSI feedback. The machine learning model may be deployed at any node in the network, which is not limited here.

In an example, the network side may determine the corresponding machine learning model based on the determined basic unit and deploy the model on the network. The UE may determine the corresponding machine learning model based on the determined basic unit and deploy the model at the UE side.

In one embodiment, the machine learning model corresponding to the basic unit is trained by using the full channel information and/or feature vector corresponding to the basic unit.

Here, for the machine learning model of each basic unit, the full channel information and/or feature vector of the corresponding basic unit may be used for training. This helps to improve the accuracy of the machine learning model in CSI processing for the basic unit.

In an example, at the network side or any node in the network, an AI model may be trained based on the basic unit, and different basic units correspond to different AI models. The input of the AI model is the parameters of the basic unit for CSI processing, for example, the full channel information and/or feature vector of the basic unit.

In one embodiment, the basic unit is determined based on the CSI measurement resource; and/or the basic unit is determined based on the CSI processing capability of the UE.

The basic unit may be determined by the UE or by the network side such as core network, base station, etc. The UE side or the network side may determine the basic unit based on the CSI measurement resource. For example, the CSI measurement resource may be divided into a plurality of basic units. The bandwidth of each divided basic unit may be the same or different.

The UE side or the network side may determine the basic unit based on the bandwidth capability of the UE to process CSI. For example, the maximum bandwidth that the UE can process CSI may be used as the basic unit. Alternatively, the maximum bandwidth that a UE with weaker processing capability in the network can process CSI may be used as the basic unit. In this way, the basic unit is enabled to meet the processing capabilities of different types of UEs. The compatibility of CSI processing is improved.

In one embodiment, in response to the bandwidth of the CSI measurement resource in frequency domain being greater than a bandwidth threshold, the bandwidth of the basic unit in frequency domain is a first bandwidth; or in response to the bandwidth of the CSI measurement resource in frequency domain being less than or equal to the bandwidth threshold, the bandwidth of the basic unit in frequency domain is a second bandwidth, where the first bandwidth is greater than the second bandwidth.

Here, when the CSI measurement resource is large, such as when the CSI measurement resource is greater than the bandwidth threshold, a basic unit with a larger bandwidth may be used. When the CSI measurement resource is small, such as when the CSI measurement resource is less than or equal to the bandwidth threshold, a basic unit with a smaller bandwidth may be used.

In an example, if the BWP bandwidth is greater than X RBs, the basic unit is 8 RBs; otherwise, the basic unit is 4 RBs. Here, X may be 100, etc.

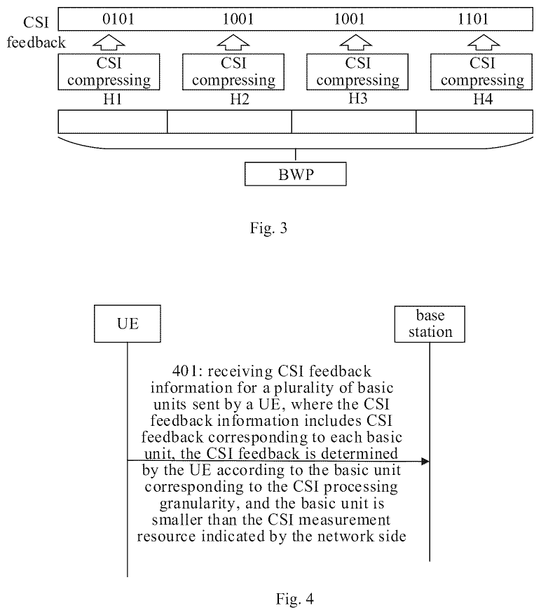

As shown in FIG. 4, an embodiment of the present disclosure provides a method for transmitting Channel Status Indicator (CSI) feedback information, which may be performed by a base station of a cellular mobile communication system, and includes the following steps.

Step 401: receiving CSI feedback information for a plurality of basic units sent by a UE, where the CSI feedback information includes CSI feedback corresponding to each basic unit, the CSI feedback is determined by the UE according to the basic unit corresponding to the CSI processing granularity, and the basic unit is smaller than the CSI measurement resource indicated by the network side.

The UE may be a terminal such as a mobile phone in a communication system.

In an example, the UE may use an AI model to process within the CSI measurement resource range with the basic unit acting as the processing granularity, so that the CSI feedback corresponding to each basic unit within the CSI measurement resource range is obtained.

In an embodiment of the present disclosure, the CSI measurement resource may be divided into I basic units, and I CSI feedbacks may be spliced into the complete CSI feedback information and sent to the base station. In an example, all of the I CSI feedbacks may be sent to the base station, and the base station may splice them into the complete CSI feedback information.

In an embodiment of the present disclosure, the UE may perform CSI processing on all or part of the basic units, and generate the CSI feedback information and send it to the base station.

In an embodiment of the present disclosure, the basic unit is smaller than the CSI measurement resource indicated by the network side. CSI may be used for the UE to feedback the downlink channel quality to the base station. The CSI measurement resource may be a time domain resource and/or a frequency domain resource of the downlink channel that the CSI can feedback. In one implementation, the CSI measurement resource may be the activated BWP of the UE. In one implementation, the basic unit is smaller than the activated BWP. That is, the activated BWP of the UE is divided into at least two basic units, so that the UE determines the CSI feedback for the basic unit.

The CSI measurement resource may be indicated by the network side. The UE may measure the channel quality within the CSI measurement resource range and provide feedback through CSI.

In an example, the CSI measurement resource may be the full bandwidth of the current data communication between the UE and the base station, or the bandwidth occupied by the CSI-RS configured by the network side, or the bandwidth range configured by the network side. The bandwidth occupied by the CSI-RS may be the bandwidth occupied by the CSI-RS at the same time domain position, or the bandwidth occupied by the CSI-RS at different time domain positions.

In an example, the UE may adopt an AI model, and perform processing within the CSI measurement resource range with the basic unit acting as the processing granularity, so that the CSI feedback corresponding to each basic unit within the CSI measurement resource range is obtained.

The UE may divide the CSI measurement resource into a plurality of basic units with the basic unit acting as the processing granularity, and perform CSI processing on each basic unit, so that the CSI feedback corresponding to each basic unit is obtained. The processing may include any of the following: measurement, prediction, or compression.

The basic unit may be the minimum resource unit of the downlink channel corresponding to the CSI that the UE can feedback. The basic unit may be a time domain resource and/or a frequency domain resource of the downlink channel. The basic unit may be determined based on the processing capability of the UE. For example, the bandwidth corresponding to the CSI feedback that can be processed by a UE with poor performance may be used as the basic unit. That is, UEs with different processing capabilities may use the basic unit as the processing granularity for the purpose of processing. The bandwidth corresponding to the CSI feedback may be the bandwidth of the downlink channel corresponding to the fed-back CSI.

For example, the basic unit for processing CS may be defined as 4 RBs or 8 RBs in frequency domain. In an implementation, the basic unit may be determined based on the number of RBs of the BWP corresponding to the UE. For example, when the BWP bandwidth is larger than X RBs, the size of the basic unit is 8 RBs; otherwise, the size of the basic unit is 4 RBs.

The basic unit may be determined based on the processing capability of the UE. For example, the bandwidth corresponding to the CSI feedback that can be processed by a UE with poor performance may be used as the basic unit. That is, UEs with different processing capabilities may use the basic unit as the processing granularity for the purpose of processing. The bandwidth corresponding to the CSI feedback may be the bandwidth of the downlink channel corresponding to the fed-back CSI.

In one embodiment, the CSI measurement resource includes I basic units, where I is a positive integer greater than or equal to 2.

When the network configures the CSI measurement resource for the terminal that needs CSI feedback, the configuration may be done with the basic unit acting as the allocation unit. The network side configures the CSI measurement resource as an integer number of basic units. For example, when the basic unit is 6 RBs, the physical resource corresponding to the object for the respective CSI measurement and feedback, that is, the CSI measurement resource, is an integer multiple of 6 RBs.

In one embodiment, the receiving the CSI feedback information sent by the User Equipment UE and containing the CSI feedback corresponding to each basic unit includes: receiving the CSI feedback information containing the CSI feedback corresponding to a plurality of basic units respectively.

The CSI measurement resource may be divided into I basic units to determine the CSI feedback corresponding to each basic unit. The CSI feedback may be combined into the CSI feedback information and sent to the base station. I is a positive integer greater than or equal to 2. In this way, the CSI of the CSI measurement resource may be fed back to realize the channel quality feedback within the CSI measurement resource range.

In an example, I CSI feedbacks may be spliced into the complete CSI feedback information and sent to the base station. In an example, I CSI feedbacks may also be sent to the base station and spliced into the complete CSI feedback information by the base station.

In this way, a basic unit smaller than the CSI measurement resource (such as BWP bandwidth) is used as the CSI processing granularity, so that UEs that do not have the CSI measurement resource as the processing granularity for CSI processing can perform CSI processing, thereby increasing the types of UEs that can perform CSI processing, reducing the resource overhead of UEs with weak compression capabilities, and improving the efficiency of CSI feedback.

In one embodiment, the CSI measurement resource is one BandWidth Part BWP.

The network side may allocate one or more BWPs to the UE. At the same time domain position, the UE may activate a BWP for data transmission. The UE may perform channel measurement or prediction for the activated BWP.

In an example, as shown in FIG. 3, a BWP may be divided into 4 basic units: H1˜H4, and CSI processing is performed based on each basic unit respectively to obtain 4 CSI feedbacks. The four CSI feedbacks are spliced into the complete CSI feedback information and sent to the base station.

The basic unit is smaller than the CSI measurement resource indicated by the network side. This may include that the basic unit is a subband of a BWP in frequency domain.

In one embodiment, the basic unit covers N frequency domain resources corresponding to the Channel State Indicator-Reference Signal CSI-RS in frequency domain, where N is a positive integer and N is less than M, and M is the total number of frequency domain resources corresponding to the CSI-RS indicated by the network side.

The network side may indicate the total number M of frequency domain resources of the CSI-RS that requires measurement by UE. The CSI measurement resource may be the bandwidth occupied by M frequency domain resources. The UE may use the bandwidth occupied by N frequency domain resources as the granularity and the basic unit to perform CSI processing, so that the CSI feedback corresponding to the basic unit is obtained.

In one embodiment, the time domain positions of the M frequency domain resources may be the same or not all the same. The CSI processing results of CSI-RS at different time domain positions may be sent to the base station through the same CSI feedback information.

In one embodiment, the time domain positions of the N frequency domain resources are the same; or the time domain positions of the N frequency domain resources are not all the same.

The N frequency domain resources covered by the basic unit may have the same time domain position. The basic unit may also cover N frequency domain resources at different time domain positions. The UE may also compress the N frequency domain resources at different time domain positions into one CSI feedback. That is, the N frequency domain resources at different time domain positions may be used as the processing unit of the CSI.

In one embodiment, as shown in FIG. 5, the method further includes the following step.

Step 501: using a machine learning model corresponding to the basic unit to decompress the CSI corresponding to the basic unit.

Step 501 may be implemented alone or in combination with step 401.

The machine learning model may perform CSI processing on the corresponding basic unit to obtain the CSI feedback of the basic unit. The machine learning model may include an AI model, etc.

For the plurality of basic units included in the CSI measurement resource, a machine learning model may be used to process the CSI of each basic unit respectively. One machine learning model may correspond to one basic unit or multiple basic units.

The number of basic units contained in different CSI measurement resources may be different. A machine learning model may be determined for each basic unit, so that the machine learning model can be used for CSI processing during the CSI processing process. The machine learning model may be determined by the network side device and then configured to the UE, or may be determined by the UE, or may be determined jointly by the UE and the network side device.

In an implementation, the network side may indicate different CSI measurement resources. The UE may determine the machine learning model from the pre-configured machine learning model for CSI processing. In this way, there is no need to retrain or configure the machine learning model according to the parameters of each CSI measurement resource, thereby reducing the management complexity of the machine learning model.

The machine learning model may be deployed at the UE side for CSI compression and other processing to obtain CSI feedback. The machine learning model may also be deployed at the network side, such as base station, for decompression of the CSI feedback. The machine learning model may be arranged at any node in the network, which is not limited here.

In an example, the network side may determine the corresponding machine learning model based on the determined basic unit and deploy the model on the network. The UE may determine the corresponding machine learning model based on the determined basic unit and deploy the model at the UE side.

In one embodiment, the machine learning model corresponding to the basic unit is trained by using the full channel information and/or feature vector corresponding to the basic unit.

Here, for each basic unit, the machine learning model may be trained by using the full channel information and/or feature vector of the corresponding basic unit. This helps to improve the accuracy of the machine learning model in CSI processing for the basic unit.

In an example, at the network side or any node in the network, an AI model may be trained based on the basic unit, and different basic units correspond to different AI models. The input of the AI model is the parameters of the basic unit for CSI processing, for example, the full channel information and/or feature vector of the basic unit.

In one embodiment, the basic unit is determined based on the CSI measurement resource; and/or the basic unit is determined based on the CSI processing capability of the UE.

The basic unit may be determined by the UE or by the network side such as core network, base station, etc.

The UE side or the network side may determine the basic unit based on the CSI measurement resource. For example, the CSI measurement resource may be divided into a plurality of basic units. The bandwidth of each divided basic unit may be the same or different.

The UE side or the network side may determine the basic unit based on the bandwidth capability of the UE to process CSI. For example, the maximum bandwidth that the UE can process CSI may be used as the basic unit. Alternatively, the maximum bandwidth that a UE with weaker processing capability in the network can process CSI may be used as the basic unit. In this way, the basic unit is enabled to meet the processing capabilities of different types of UEs. The compatibility of CSI processing is improved.

In one embodiment, in response to the bandwidth of the CSI measurement resource in frequency domain being greater than a bandwidth threshold, the bandwidth of the basic unit in frequency domain is a first bandwidth; or in response to the bandwidth of the CSI measurement resource in frequency domain being less than or equal to the bandwidth threshold, the bandwidth of the basic unit in frequency domain is a second bandwidth, where the first bandwidth is greater than the second bandwidth.

Here, when the CSI measurement resource is large, such as when the CSI measurement resource is greater than the bandwidth threshold, a basic unit with a larger bandwidth may be used. When the CSI measurement resource is small, such as when the CSI measurement resource is less than or equal to the bandwidth threshold, a basic unit with a smaller bandwidth may be used.

For example, if the BWP bandwidth is larger than X RBs, the basic unit is 8 RBs; otherwise, the basic unit is 4 RBs. Here, X may be 100, etc.

The following provides a specific example in combination with any of the above embodiments.
1. The basic unit for CSI compression processing is defined. The basic unit may be a frequency subband or N time-frequency resources used by CSI-RS.

Sizes of multiple basic units may be defined at the system side, and different basic units may be determined by different terminal processing capabilities or different system bandwidths. For example, the basic unit for CSI compression may be defined as 4 RBs or 8 RBs. When the BWP bandwidth is larger than X RBs, the size of the basic unit is 8 RBs; otherwise, the size of the basic unit is 4 RBs.

The AI model may be trained based on the size of the basic unit at the network side or the server side, and different basic unit structures correspond to different AI models. The input of the AI model corresponds to the full channel information or feature vector corresponding to the basic unit for CSI processing.

In response to the definition of multiple basic processing units, the network/terminal side downloads the corresponding model according to the determined basic unit size and deploys the model at the network/terminal side.
2. When the network configures the terminal with a resource that requires CSI feedback, the configuration may be done with the basic unit, and the resource is configured as an integer number of the basic units. For example, when the basic processing unit is 6 RBs, the physical resources corresponding to the object for the respective CSI measurement and feedback are integer multiples of 6 RBs
3. Terminal side action(s).

When the terminal performs CSI compression, the CSI compression is performed in sequence in frequency domain in units of basic units.

When the terminal performs CSI feedback, the feedback is the bit after CSI compression and N basic units.
4. Base station side action(s).

When receiving the CSI feedback, the base station side divides the entire CSI feedback bit into feedback bits corresponding to N basic CSI processing units. The terminal decompresses the feedback bits corresponding to each processing unit and replies the channel information corresponding to each processing unit.

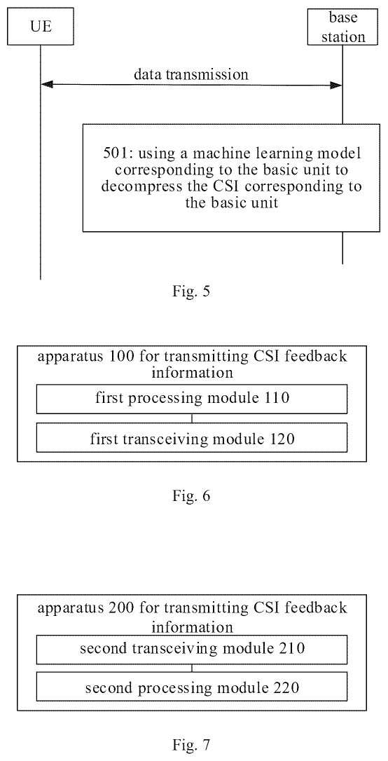

An embodiment of the present disclosure further provides an apparatus for transmitting CSI feedback information, as shown in FIG. 6, which is applied to UE, and the apparatus 100 for transmitting CSI feedback information includes a first processing module 110 and a first transceiving module 120.

The first processing module 110 is configured to determine the CSI feedback corresponding to each basic unit according to the basic unit of the CSI processing granularity, where the basic unit is smaller than the CSI measurement resource indicated by the network side.

The first transceiving module 120 is configured to send the CSI feedback information containing the CSI feedback to the base station.

In one embodiment, the CSI measurement resource is 1 BandWidth Part BWP.

In one embodiment, the basic unit covers N frequency domain resources corresponding to the Channel State Indicator-Reference Signal CSI-RS in frequency domain, where N is a positive integer, N is less than M, and M is the total number of frequency domain resources corresponding to the CSI-RS indicated by the network side.

In one embodiment, the time domain positions of the N frequency domain resources are the same; or the time domain positions of the N frequency domain resources are not all the same.

In one embodiment, the first processing module is specifically configured to: determine the basic unit of the CSI processing granularity; and use the machine learning model corresponding to the basic unit to determine the CSI feedback corresponding to the basic unit.

In one embodiment, the machine learning model corresponding to the basic unit is trained by using the full channel information and/or feature vector corresponding to the basic unit.

In one embodiment, the first transceiving module 120 is specifically configured to: send the CSI feedback information containing the CSI feedback corresponding to a plurality of basic units respectively.

In one embodiment, the basic unit is determined based on the CSI measurement resource; and/or the basic unit is determined based on the CSI processing capability of the UE.

In one embodiment, in response to the bandwidth of the CSI measurement resource in frequency domain being greater than a bandwidth threshold, the bandwidth of the basic unit in frequency domain is a first bandwidth; or in response to the bandwidth of the CSI measurement resource in frequency domain being less than or equal to the bandwidth threshold, the bandwidth of the basic unit in frequency domain is a second bandwidth, where the first bandwidth is greater than the second bandwidth.

In one embodiment, the CSI measurement resource includes I basic units, where I is a positive integer greater than or equal to 2.

An embodiment of the present disclosure further provides an apparatus for transmitting CSI feedback information. As shown in FIG. 7, the apparatus 200 for transmitting CSI feedback information is applied to a base station. The apparatus 200 for transmitting CSI feedback information includes a second transceiving module 210.

The second transceiving module 210 is configured to receive the CSI feedback information for a plurality of basic units sent by a User Equipment UE. The CSI feedback information includes CSI feedback corresponding to each basic unit. The CSI feedback is determined by the UE according to the basic unit corresponding to the CSI processing granularity. The basic unit is smaller than the CSI measurement resource indicated by the network side.

In one embodiment, the CSI measurement resource is 1 BandWidth Part BWP.

In one embodiment, the basic unit covers N frequency domain resources corresponding to the Channel State Indicator-Reference Signal CSI-RS in frequency domain, where N is a positive integer, N is less than M, and M is the total number of frequency domain resources corresponding to the CSI-RS indicated by the network side.

In one embodiment, the time domain positions of the N frequency domain resources are the same; or the time domain positions of the N frequency domain resources are not all the same.

In one embodiment, the apparatus 200 further includes a second processing module 220.

The second processing module 220 is configured to use a machine learning model corresponding to the basic unit to decompress the CSI corresponding to the basic unit.

In one embodiment, the machine learning model corresponding to the basic unit is trained by using the full channel information and/or feature vector corresponding to the basic unit.

In one embodiment, the receiving the CSI feedback information sent by the User Equipment UE and containing the CSI feedback corresponding to each basic unit includes: receiving the CSI feedback information containing the CSI feedback corresponding to a plurality of basic units respectively.

In one embodiment, the basic unit is determined based on the CSI measurement resource; and/or the basic unit is determined based on the CSI processing capability of the UE.

In one embodiment, in response to the bandwidth of the CSI measurement resource in frequency domain being greater than a bandwidth threshold, the bandwidth of the basic unit in frequency domain is a first bandwidth; or in response to the bandwidth of the CSI measurement resource in frequency domain being less than or equal to the bandwidth threshold, the bandwidth of the basic unit in frequency domain is a second bandwidth, where the first bandwidth is greater than the second bandwidth.

In one embodiment, the CSI measurement resource includes I basic units, where I is a positive integer greater than or equal to 2.

In an example embodiment, the first processing module 110, the first transceiving module 120, the second transceiving module 210, and the second processing module 220, etc., may be implemented by one or more Central Processing Units (CPUs), Graphics Processing Units (GPUs), Baseband Processors (BPs), Application-Specific Integrated Circuits (ASICs), DSPs, Programmable Logic Devices (PLDs), Complex Programmable Logic Devices (CPLDs), Field-Programmable Gate Arrays (FPGAs), general-purpose processors, controllers, Micro Controller Units (MCUs), Microprocessors, or other electronic components to perform the aforementioned method.

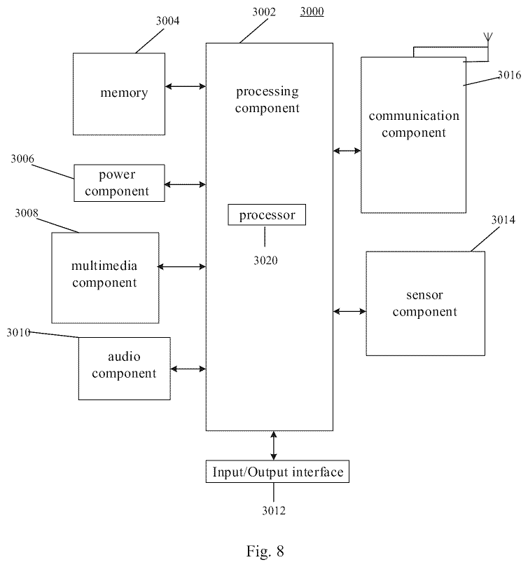

FIG. 8 is a block diagram of an apparatus 3000 for transmitting CSI feedback information according to an example embodiment. For example, the apparatus 3000 may be a mobile phone, a computer, a digital broadcast terminal, a messaging device, a game console, a tablet device, a medical device, a fitness device, a personal digital assistant, etc.

Referring to FIG. 8, the apparatus 3000 may include one or more of the following components: a processing component 3002, a memory 3004, a power component 3006, a multimedia component 3008, an audio component 3010, an Input/Output (I/O) interface 3012, a sensor component 3014, and a communication component 3016.

The processing component 3002 generally controls the overall operation of the apparatus 3000, such as operations associated with display, phone calls, data communications, camera operations, and recording operations. The processing component 3002 may include one or more processors 3020 to execute instructions to complete all or part of the steps of the above method. In addition, the processing component 3002 may include one or more modules to facilitate interactions between the processing component 3002 and other components. For example, the processing component 3002 may include a multimedia module to facilitate interactions between the multimedia component 3008 and the processing component 3002.

The memory 3004 is configured to store various types of data to support operations on the apparatus 3000. Examples of such data include instructions for any application or method operating on the apparatus 3000, contact data, phone book data, messages, pictures, videos, etc. The memory 3004 may be implemented by any type of volatile or non-volatile storage device or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or optical disk.

The power component 3006 provides power to various components of the apparatus 3000. The power component 3006 may include a power management system, one or more power supplies, and other components associated with generating, managing, and distributing power for the apparatus 3000.

The multimedia component 3008 includes a screen that provides an output interface between the apparatus 3000 and the user. In some embodiments, the screen may include a Liquid Crystal Display (LCD) and a Touch Panel (TP). If the screen includes a touch panel, the screen may be implemented as a touch screen to receive input signals from a user. The touch panel includes one or more touch sensors to sense touch, slide, and gestures on the touch panel. The touch sensors may not only sense the boundaries of a touch or slide operation, but also detect the duration and pressure associated with the touch or slide operation. In some embodiments, the multimedia component 3008 includes a front camera and/or a rear camera. When the apparatus 3000 is in an operation mode, such as a shooting mode or a video mode, the front camera and/or the rear camera may receive external multimedia data. Each of the front camera and the rear camera may be a fixed optical lens system or have a focal length and optical zooming capability.

The audio component 3010 is configured to output and/or input audio signals. For example, the audio component 3010 includes a microphone (MIC). When the apparatus 3000 is in an operation mode, such as a call mode, a recording mode, and a voice recognition mode, the microphone is configured to receive an external audio signal. The received audio signal may be further stored in the memory 3004 or sent via the communication component 3016. In some embodiments, the audio component 3010 also includes a speaker for outputting audio signals.

The I/O interface 3012 provides an interface between the processing component 3002 and the peripheral interface module, which may be a keyboard, a click wheel, a button, etc. These buttons may include, but are not limited to, a home button, a volume button, a start button, and a lock button.

The sensor component 3014 includes one or more sensors for providing various aspects of status assessment for the apparatus 3000. For example, the sensor component 3014 may detect the on/off state of the apparatus 3000, the relative positioning among components, such as display and keypad of the apparatus 3000. The sensor component 3014 may further detect the position change of the apparatus 3000 or a component of the apparatus 3000, the presence or absence of user contact with the apparatus 3000, the orientation or acceleration/deceleration of the apparatus 3000, and the temperature change of the apparatus 3000. The sensor component 3014 may include a proximity sensor configured to detect the presence of a nearby object without any physical contact. The sensor component 3014 may further include a light sensor, such as a CMOS or CCD image sensor, for use in imaging applications. In some embodiments, the sensor component 3014 may also include an acceleration sensor, a gyroscope sensor, a magnetic sensor, a pressure sensor, or a temperature sensor.

The communication component 3016 is configured to facilitate wired or wireless communication between the apparatus 3000 and other devices. The apparatus 3000 can access a wireless network based on a communication standard, such as Wi-Fi, 2G or 3G, or a combination thereof. In an example embodiment, the communication component 3016 receives a broadcast signal or broadcast-related information from an external broadcast management system via a broadcast channel. In an example embodiment, the communication component 3016 further includes a Near Field Communication (NFC) module to facilitate short-range communication. For example, the NFC module may be implemented based on Radio Frequency Identification (RFID) technology, Infrared Data Association (IrDA) technology, Ultra-WideBand (UWB) technology, Bluetooth (BT) technology, and other technologies.

In an example embodiment, the apparatus 3000 may be implemented by one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components to perform the above methods.

In an example embodiment, a non-transistory computer-readable storage medium including instructions is further provided, such as a memory 3004 including instructions, which can be executed by a processor 3020 of the apparatus 3000 to complete the above method. For example, the non-transistory computer-readable storage medium may be a ROM, a Random Access Memory (RAM), a CD-ROM, a tape, a floppy disk, and an optical data storage device, etc.

After considering the specification and practicing the content disclosed herein, it will be easy for a person skilled in the art to think of other embodiments of the present disclosure. This application is intended to cover any variation, use, or adaptive change of the embodiments of the present disclosure, which follows the general principles of the embodiments of the present disclosure and includes common knowledge or conventional technical means in the art that are not disclosed in the embodiments of the present disclosure. The description and embodiments are to be regarded as example only, and the true scope and spirit of the embodiments of the present disclosure are indicated by the following claims.

It should be understood that the embodiments of the present disclosure are not limited to the precise structure described above and shown in the drawings, and various modifications and changes may be made without departing from the scope thereof. The scope of the embodiments of the present disclosure is limited only by the appended claims.

1. A method for transmitting Channel State Indicator (CSI) feedback information, performed by a User Equipment (UE), and comprising:
determining CSI feedback corresponding to each basic unit according to the basic unit of a CSI processing granularity, wherein the basic unit is smaller than a CSI measurement resource indicated by a network side; and
sending the CSI feedback information comprising the CSI feedback to a base station.

2. The method according to claim 1, wherein the CSI measurement resource is one BandWidth Part (BWP).

3. The method according to claim 1, wherein
the basic unit covers N frequency domain resources corresponding to a Channel State Indicator-Reference Signal (CSI-RS) in frequency domain,
wherein N is a positive integer and N is less than M; and
wherein M is a total number of frequency domain resources corresponding to the CSI-RS indicated by the network side.

4. The method according to claim 3, wherein
time domain positions of the N frequency domain resources are the same; or
the time domain positions of the N frequency domain resources are not all the same.

5. The method according to claim 1, wherein the determining the CSI feedback corresponding to each basic unit according to the basic unit of the CSI processing granularity comprises:
determining the basic unit of the CSI processing granularity; and
using a machine learning model corresponding to the basic unit to determine the CSI feedback corresponding to the basic unit.

6. The method according to claim 5, wherein
the machine learning model corresponding to the basic unit is obtained by training with at least one of full channel information or feature vector corresponding to the basic unit.

7. The method according to claim 1, wherein the sending the CSI feedback information comprising the CSI feedback to the base station comprises:
sending the CSI feedback information comprising the CSI feedback corresponding to a plurality of basic units respectively.

8. The method according to claim 1, wherein the basic unit is determined based on at least one of the CSI measurement resource or CSI processing capability of the UE.

9. The method according to claim 8, wherein
in response to a bandwidth of the CSI measurement resource in frequency domain being greater than a bandwidth threshold, a bandwidth of the basic unit in frequency domain is a first bandwidth; or
in response to the bandwidth of the CSI measurement resource in frequency domain being less than or equal to the bandwidth threshold, the bandwidth of the basic unit in frequency domain is a second bandwidth,
wherein the first bandwidth is greater than the second bandwidth.

10. The method according to claim 1, wherein
the CSI measurement resource comprises I basic units, wherein I is a positive integer greater than or equal to 2.

11. A method for transmitting Channel State Indicator (CSI) feedback information, performed by a base station, and comprising:
receiving CSI feedback information for a plurality of basic units sent by a User Equipment UE,
wherein the CSI feedback information comprises CSI feedback corresponding to each basic unit;
wherein the CSI feedback is determined by the UE according to the basic unit corresponding to a CSI processing granularity; and
wherein the basic unit is smaller than a CSI measurement resource indicated by a network side.

12. (canceled)

13. The method according to claim 11, wherein
the basic unit covers N frequency domain resources corresponding to a Channel State Indicator-Reference Signal (CSI-RS) in frequency domain,
wherein N is a positive integer and N is less than M; and
wherein M is a total number of frequency domain resources corresponding to the CSI-RS indicated by the network side.

14. The method according to claim 13, wherein
time domain positions of the N frequency domain resources are the same; or
the time domain positions of the N frequency domain resources are not all the same.

15. The method according to claim 11, further comprising:
using a machine learning model corresponding to the basic unit to decompress the CSI corresponding to the basic unit.

16. The method according to claim 15, wherein
the machine learning model corresponding to the basic unit is obtained by training with at least one of full channel information or feature vector corresponding to the basic unit.

17. The method according to claim 11, wherein the receiving the CSI feedback information comprising the CSI feedback corresponding to each basic unit and sent by the User Equipment UE comprises:
receiving the CSI feedback information comprising the CSI feedback corresponding to the plurality of basic units respectively.

18. The method according to claim 11, wherein the basic unit is determined based on at least one of the CSI measurement resource or CSI processing capability of the UE.

19. The method according to claim 18, wherein
in response to a bandwidth of the CSI measurement resource in frequency domain being greater than a bandwidth threshold, a bandwidth of the basic unit in frequency domain is a first bandwidth; or
in response to the bandwidth of the CSI measurement resource in frequency domain being less than or equal to the bandwidth threshold, the bandwidth of the basic unit in frequency domain is a second bandwidth,
wherein the first bandwidth is greater than the second bandwidth.

20.-40. (canceled)

41. A communication device, comprising:
a processor; and
a memory storing a program executable by the processor;
wherein the processor is configured to:
determine Channel State Indicator (CSI) feedback corresponding to each basic unit according to the basic unit of a CSI processing granularity, wherein the basic unit is smaller than a CSI measurement resource indicated by a network side; and
send the CSI feedback information comprising the CSI feedback to a base station.

42. (canceled)

43. A communication device, comprising:
a processor; and
a memory storing a program executable by the processor;
wherein the processor is configured to perform the method according to claim 11.
